(19) United States
(12) Patent Application Publication
(10) Pub. No.: US 2018/0184235 A1
(43) Pub. Date: Jun. 28, 2018

(54) REMOTE BLUETOOTH DEVICE COMMUNICATION SYSTEM AND METHOD THEREOF

(71) Applicant: LINCTRONIX LTD., New Tapei City (TW)

(72) Inventor: Chia-Jen Wu, New Tapei City (TW)

(21) Appl. No.: 15/856,320

(22) Filed: Dec. 28, 2017

(30) Foreign Application Priority Data
Dec. 28, 2016 (TW) 105143514

(51) Int. Cl. H04W 4/00

(52) U.S. Cl. CPC H04W 4/008; H04W 80/04

(57) ABSTRACT

The present invention discloses a remote Bluetooth device communication system comprising a Bluetooth manager, a Bluetooth agent and a Bluetooth peripheral. The Bluetooth manager sends a TCP/IP management packet to the Bluetooth agent. The Bluetooth agent receives the TCP/IP management packet and interprets the TCP/IP management packet to one or a series of Bluetooth GAP/GATT operations. The Bluetooth peripheral receives the Bluetooth GAP/GATT message and executes the Bluetooth GAP/GATT operation accordingly. Compared with the prior art, this invention translates the Bluetooth GAP/GATT message to the TCP/IP management packet by the Bluetooth agent and uses the TCP/IP link to achieve remote communication. This present invention realizes the Bluetooth communication over IP network.

### CROSS-REFERENCE TO RELATED APPLICATIONS

This application claims priority to Taiwan Patent Application No. 105143514, entitled “REMOTE BLUETOOTH DEVICE COMMUNICATION SYSTEM AND METHOD THEROF”, filed Dec. 28, 2016, the contents of which are hereby incorporated by reference in their entirety to the extent permitted by law.

### BACKGROUND OF THE INVENTION

### Field of the Invention

The present invention relates to a remote Bluetooth device communication system and method thereof, more particularly, to a remote Bluetooth device communication system and method of interpreting the TCP/IP management packets and the Bluetooth GAP/GATT messages to each other.

### Description of the Prior

Bluetooth wireless transmission technology is one of the currently most widely used short-range wireless transmission standards in the world. In 2010, the Bluetooth 4.0 version of the communication protocol includes three Bluetooth protocols: the classic Bluetooth protocol, the high-speed Bluetooth protocol and the low-energy Bluetooth protocol, and combines the three specifications into one. The Bluetooth 4.0 inherits the advantages of Bluetooth technology in wireless communication, and in the meanwhile adds the features of high-speed Bluetooth and low-energy Bluetooth. These three specifications can be combined to be used or used alone. The core of Bluetooth 4.0 communication protocol is low-energy technology, that is, Bluetooth 4.0 BLE communication protocol. The technology is characterized by ultra-low operating energy consumption and standby energy consumption. Bluetooth low-energy equipment using a button-type battery can even work continuously for several years. Moreover, the features of Bluetooth 4.0 protocol are low cost, high stability, fast connection and high security at the same time.

Although Bluetooth technology has the above advantages, Bluetooth protocol stack has its own transport layer and lack of network layer. This means Bluetooth communication cannot cross an IP network. The native Bluetooth supports only point to point communication. Users cannot control a Bluetooth peripheral from anywhere in the world.

### SUMMARY OF THE INVENTION

In response to the above-mentioned problems, an object of the present invention is to provide a remote Bluetooth device communication system that can control the Bluetooth peripherals anywhere. In an embodiment, the remote Bluetooth device communication system of the present invention comprises a Bluetooth manager, a Bluetooth agent, and a Bluetooth peripheral. The Bluetooth manager sends a TCP/IP management packet to the Bluetooth agent in order to access the Bluetooth peripheral. The Bluetooth agent receives the management packet, and interprets the management packet into one or a series of Bluetooth GAP/GATT (Generic Access Profile/Generic Attribute Profile) operations. The Bluetooth agent acts as a Bluetooth central while communicating with the Bluetooth peripheral. The Bluetooth peripheral responds the result of Bluetooth GAP/GATT operations to the Bluetooth agent. The Bluetooth agent encapsulated the received GAP/GATT message into an TCP/IP management packet and forwards it to the Bluetooth manager. In the above-mentioned embodiment, the Bluetooth manager initiates a bi-direction communication with a remote Bluetooth peripheral. In another embodiment, the Bluetooth peripheral initiates a Bluetooth message and sends it to the Bluetooth agent. The Bluetooth agent encapsulated the received Bluetooth message into a TCP/IP management packet. The Bluetooth agent forwards the TCP/IP management packet to the Bluetooth manager across the IP network.

In an embodiment, the TCP/IP management packet may be a Bluetooth management TCP/IP packet.

In another embodiment, the remote Bluetooth device communication system comprises a Bluetooth manager and a Bluetooth agent as mentioned above, and further comprises a plurality of Bluetooth peripherals. The Bluetooth agent forwards the management command or data to a plurality of Bluetooth peripherals by broadcasting GAP message or sending the same GATT message to the specified Bluetooth peripherals one by one. The plurality of Bluetooth peripherals receive the Bluetooth GAP/GATT message at the same time and responds the result of GAP/GATT operations to the Bluetooth agent. In this embodiment, the remote Bluetooth device communication system could implement the simultaneously access to a plurality of Bluetooth peripherals. In another embodiment, the remote Bluetooth device communication system comprises a plurality of Bluetooth agents and a Bluetooth manager as mentioned above, and further comprises a plurality of Bluetooth peripherals. The Bluetooth manage sends a broadcast or multicast TCP/IP management packet to the plurality of Bluetooth agents, the plurality of Bluetooth agents interpret the delivered management packet simultaneously. In this embodiment, the remote Bluetooth device communication system could implement the purpose of a Bluetooth manager simultaneously accessing the plurality of Bluetooth peripherals under different Bluetooth agents.

In an embodiment of present invention, the Bluetooth peripheral is a device compatible with the general IEEE802.15.1 standard.

Another object of the present invention is to provide a remote Bluetooth device communication method, the remote Bluetooth device communication method comprises the following steps: A1: A Bluetooth manager sends a TCP/IP management message in order to access a specified Bluetooth peripheral; A2: A Bluetooth agent interprets the delivered TCP/IP management message into one or a series of Bluetooth GAP/GATT messages; and A3: A Bluetooth peripheral receives the Bluetooth GAP/GATT messages, and proceeding the GAP/GATT operations accordingly.

Another embodiment of the present invention comprises the following method: B1: A Bluetooth peripheral sends its own data to a Bluetooth agent by advertising a Bluetooth GAP message or forwarding a Bluetooth GATT message via a Bluetooth connection; B2: The Bluetooth agent encapsulates the delivered Bluetooth GAP/GATT message into a TCP/IP management packet; and B3: A Bluetooth manager receives the TCP/IP management packet, which carries the data of Bluetooth peripheral, from the Bluetooth agent.

In another embodiment, the step A2 further comprises the following steps: A21: The Bluetooth agent receives the TCP/IP management packet and interprets the TCP/IP management packet into one or a series of Bluetooth GAP/GATT operations; and A22: The Bluetooth agent sends the Bluetooth GAP/GATT messages to the Bluetooth peripheral.

In another embodiment of the present invention, the step B2 further comprises the following steps: B21: The Bluetooth agent receives the Bluetooth GAP/GATT messages; and B22: The Bluetooth agent encapsulates the Bluetooth GAP/GATT messages into a TCP/IP management packet for the Bluetooth manager.

Another object of the present invention is to provide a remote Bluetooth device communication multipoint synchronous operation method; the remote Bluetooth device communication method comprises the following steps: C1: A Bluetooth manager sends a TCP/IP management packet to a Bluetooth agent; C2: The Bluetooth agent interprets the received TCP/IP management packet into one or a series of Bluetooth GAP/GATT operations, and sends the Bluetooth GAP/GATT messages to a plurality of Bluetooth peripherals; and C3: the plurality of Bluetooth peripherals receive the Bluetooth GAP/GATT messages and execute the operations accordingly.

Another object of the present invention is to provide a remote Bluetooth device communication multipoint synchronous operation method; the remote Bluetooth device communication method comprises the following steps: D1: A Bluetooth manager sends a broadcast or a multicast TCP/IP management packet to one or a plurality of Bluetooth agents; D2: One or a plurality of Bluetooth agents interpret the delivered TCP/IP management packet into one or a series of Bluetooth GAP/GATT messages, and then send the Bluetooth GAP/GATT messages to specific Bluetooth peripherals respectively; and D3: The specific Bluetooth peripherals receive the Bluetooth GAP/GATT message from one of the plurality of Bluetooth agents and execute the GAP/GATT operations accordingly.

Compare to the prior art, the remote Bluetooth device communication system of the present invention translates the Bluetooth GAP/GATT messages to the TCP/IP management packet by the Bluetooth agent and uses the TCP/IP technology to carry the Bluetooth data across an IP network. Through this mechanism, the purpose of a single Bluetooth manager accessing a plurality of Bluetooth peripherals across Internet can be realized.

### BRIEF DESCRIPTION OF THE APPENDED DRAWINGS

Some of the embodiments will be described in detail, with reference to the following figures, wherein like designations denote like members, wherein:

FIG. 1 shows a functional block diagram of the embodiment of the remote Bluetooth device communication system of the present invention.

FIG. 2 shows a schematic diagram of the data encapsulation and interpret flow inside the Bluetooth agent of the remote Bluetooth device communication system of the present invention.

FIG. 3 shows a schematic diagram of the data transmission across Internet and Bluetooth of the remote Bluetooth device communication system of the present invention.

FIG. 4 shows a schematic diagram of the one to many simultaneous data delivery of the remote Bluetooth device communication system of the present invention.

FIG. 5 shows a manager to peripheral data process flow diagram of the remote Bluetooth device communication method of the present invention.

FIG. 6 shows a peripheral to manager data process flow diagram of the remote Bluetooth device communication method of the present invention.

FIG. 7 shows a manager to multi-peripheral data process flow diagram of synchronous operation of the remote Bluetooth device communication method of the present invention.

FIG. 8 shows a multi-peripheral to manager data process flow diagram of synchronous operation of the remote Bluetooth device communication method of the present invention.

The advantages, spirits, and features of the present invention will be explained and discussed with embodiments and figures as follows.

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications can be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

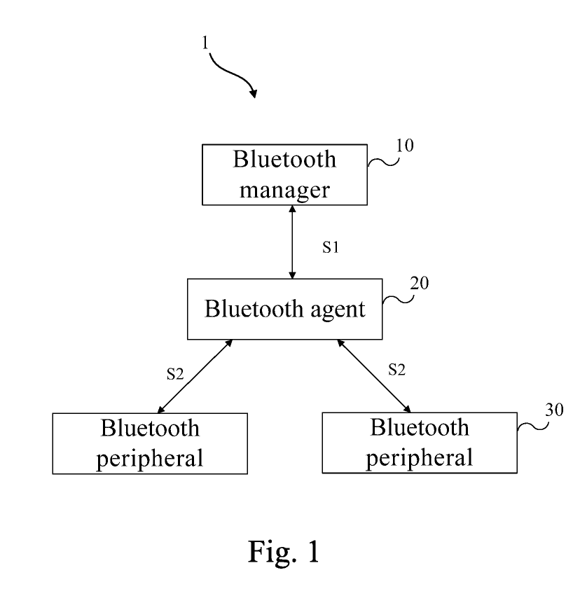

Please refer to FIG. 1. FIG. 1 shows a functional block diagram of the embodiment of the remote Bluetooth device communication system 1 of the present invention. The remote Bluetooth device communication system 1 of the present invention comprises a Bluetooth manager 10, a Bluetooth agent 20, and a Bluetooth peripheral 30. The Bluetooth manager 10 sends a Bluetooth management TCP/IP packet S1 to the Bluetooth agent 20 via internet. The Bluetooth agent 20 receives and interprets the Bluetooth management TCP/IP packet S1, Bluetooth agent 20 interprets the Bluetooth management TCP/IP packet S1 compatible with internet protocol to a Bluetooth GAP/GATT message S2 compatible with Bluetooth communication protocol, and then sends the Bluetooth GAP/GATT message S2 to the Bluetooth peripheral 30 via a Bluetooth connection. The Bluetooth peripheral 30 receives the Bluetooth GAP/GATT message S2 and executes action according to the content or the command of the Bluetooth GAP/GATT message S2. The Bluetooth peripheral could be any device compatible with the general IEEE802.15.1 standard. Wherein, the Bluetooth peripheral 30 may send a Bluetooth GAP/GATT message S3 compatible with Bluetooth communication protocol via a Bluetooth connection. The Bluetooth agent 20 receives the Bluetooth GAP/GATT message S3 and interprets the Bluetooth GAP/GATT message S3 to a Bluetooth management TCP/IP packet S4 compatible with internet protocol, and sends the Bluetooth management TCP/IP packet S4 to the Bluetooth manager 10 via internet. In this embodiment, the content or the command of the Bluetooth management TCP/IP packet and the Bluetooth GAP/GATT message comprises, but not limited to, voice message, image message, video message, communication message, device linking message, data transferring message, or other types of message.

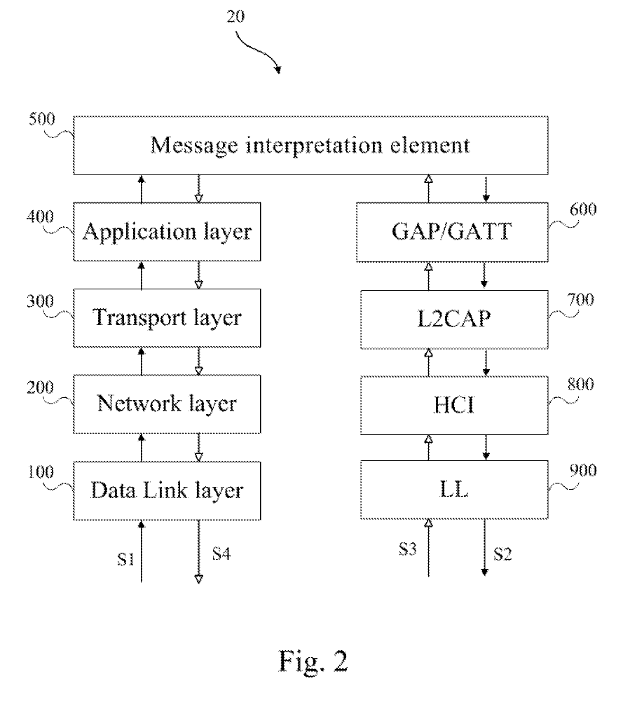

Please refer to FIG. 2. FIG. 2 shows a schematic diagram of the data transmission of the Bluetooth agent 20 of the remote Bluetooth device communication system 1 of the present invention. The Bluetooth agent 20 may be a codec, as shown in FIG. 2. The Bluetooth management TCP/IP packet S1 is inputted into the Bluetooth agent 20, and the Bluetooth management TCP/IP packet S1 is interpreted through the data link layer 100, the network layer 200, the transport layer 300, and the application layer 400 according to TCP/IP protocol suite. Then, the message interpretation element 500 packets the interpreted message to a Bluetooth GAP/GATT message S2 through the Generic Access Profile/Generic Attribute Profile (GAP/GATT) 600, the Logical Link Control and Adaptation Layer Protocol (L2CAP) 700, the Host Controller Interface (HCI) 800, and the Link Layer (LL) 900.

As shown in FIG. 2, a Bluetooth GAP/GATT message S3 is inputted into the Bluetooth agent 20, and the Bluetooth GAP/GATT message S3 is interpreted through the Link Layer (LL) 900, the Host Controller Interface (HCI) 800, the Logical Link Control and Adaptation Layer Protocol (L2CAP) 700, and the Generic Access Profile/Generic Attribute Profile (GAP/GATT) 600. Then, the message interpretation element 500 packets the interpreted message to the Bluetooth management TCP/IP packet S4 through the application layer 400, the transport layer 300, the network layer 200, and the data link layer 100 according to TCP/IP protocol suite, and the Bluetooth management TCP/IP packet S4 is send to a Bluetooth manager 10.

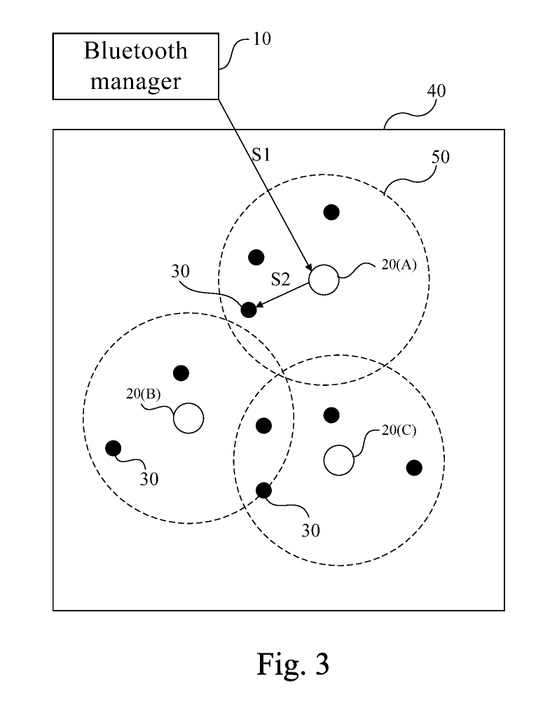

Please refer to FIG. 3. FIG. 3 shows a schematic diagram of the data transmission across Internet and Bluetooth of the remote Bluetooth device communication system 1 of the present invention. Additionally, the diagram is simplified in this paragraph for convenience of explanation. In an embodiment, the Bluetooth manager 10 may be a central computer of a hospital as shown in FIG. 3. The Bluetooth agent 20 could be a Bluetooth transceiver with decoding and interpreting capability, and internet connectivity. A plurality of Bluetooth agents 20(A), 20(B) and 20(C) may be configured. The Bluetooth peripheral 30 can be a Bluetooth band, or pager with a Bluetooth function. When completing the registration procedure and wearing a Bluetooth band provided by the hospital, the patient can move freely within the hospital, for example, the patient can move freely within the activity space 40. The central computer (the Bluetooth manager 10) sends the Bluetooth management TCP/IP packet S1 loaded with a command of Bluetooth searching to the plurality of Bluetooth transceivers (the Bluetooth agent 20). After the Bluetooth transceiver decodes and interprets the command, the Bluetooth transceiver searches for a specific Bluetooth band in a signal coverage range of each Bluetooth transceiver according to the Media Access Control Address (MAC) of each Bluetooth band (the Bluetooth peripheral 30), and then reports the result to the Bluetooth manager 10. When at least one Bluetooth transceiver finds the Bluetooth band of the patient, the Bluetooth manager 10 sends a text message, a voice message, or a light message via a Bluetooth management TCP/IP packet S1 to the Bluetooth transceiver closest to the Bluetooth band. The Bluetooth transceiver interprets the Bluetooth management TCP/IP packet S1 to the Bluetooth GAP/GATT message S2 and sends the Bluetooth GAP/GATT message S2 to the Bluetooth band. The Bluetooth band shows the text, sounds, or glows the light to make the patient be notified.

In another embodiment, a patient presses the button or interface of the Bluetooth band (the Bluetooth peripheral 30) when attending to call a medical assistance solely in hospital, and then the Bluetooth band sends out the Bluetooth GAP/GATT message S3. After one or more Bluetooth transceivers (the Bluetooth agent 20) receive the message, one or more Bluetooth transceivers code the content of message and the MAC of the Bluetooth band to the Bluetooth management TCP/IP packet S4, and send the Bluetooth management TCP/IP packet S4 to the central computer (the Bluetooth manager 10). The central computer decodes and determines who is calling and from where, and informs the medical staff to handle through the human-machine interface.

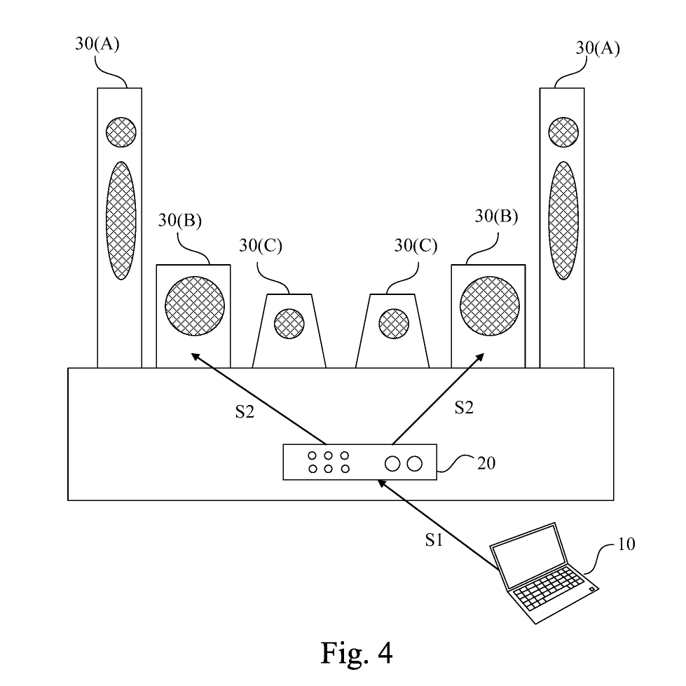

Please refer to FIG. 4. FIG. 4 shows a schematic diagram of the one to many simultaneous data delivery synchronization of the remote Bluetooth device communication system 1 of the present invention. In an embodiment, the Bluetooth manager 10 can be a notebook. The Bluetooth agent 20 can be a Bluetooth transceiver with decoding and interpreting capability. The Bluetooth peripheral 30 can be a plurality of Bluetooth speakers with the same or different properties, for example, a set of multi-channel Bluetooth speakers includes Bluetooth speakers 30(A), Bluetooth speakers 30(B) and Bluetooth speakers 30(C). When the notebook (the Bluetooth manager 10) requires the bass sound effect when playing music, the notebook sends a bass sound command message (the Bluetooth management TCP/IP packet S1). After the Bluetooth transceiver interprets the message, the Bluetooth transceiver searches the Bluetooth bass speakers according to the specific MAC address of each Bluetooth speaker. When the Bluetooth transceiver finds out that both of the speakers of the Bluetooth speakers 30(B) are Bluetooth bass speakers, the Bluetooth transceiver sends the command message to both of the speakers of Bluetooth speakers 30(B) to make the Bluetooth speakers 30(B) booms out the bass voice.

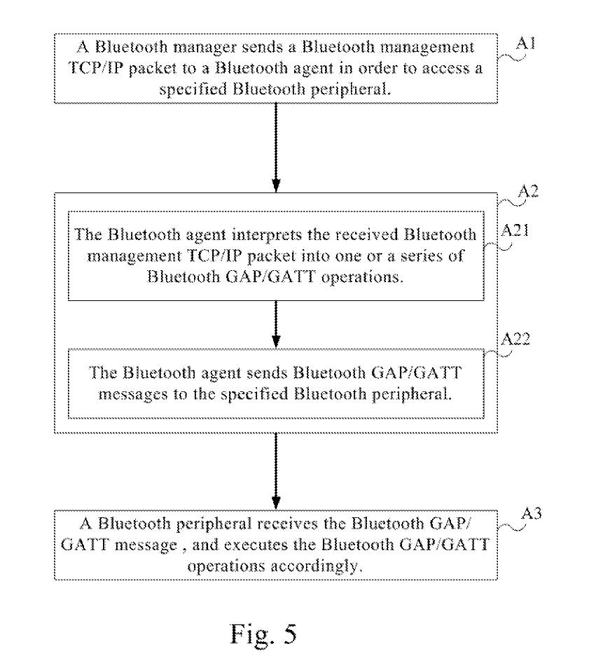

Please refer to FIG. 5. FIG. 5 shows a process flow diagram of the remote Bluetooth device communication method of the present invention. Another object of the present invention is to provide a remote Bluetooth device communication method, and the method comprises the following steps: A1: A Bluetooth manager sends a Bluetooth management TCP/IP packet to a Bluetooth agent in order to access a specified Bluetooth peripheral; A2: The Bluetooth agent interprets the received Bluetooth management packet into one or a series of Bluetooth GAP/GATT messages; and A3: The specified Bluetooth peripheral receives the Bluetooth GAP/GATT message, and executes Bluetooth GAP/GATT operations accordingly. In more detail, the step A2 of the foregoing remote Bluetooth device communication method further comprises the following steps: A21: The Bluetooth agent interprets the received Bluetooth management TCP/IP packet into one or a series of Bluetooth GAP/GATT operations; and A22: The Bluetooth agent sends the Bluetooth GAP/GATT messages to the specified Bluetooth peripheral.

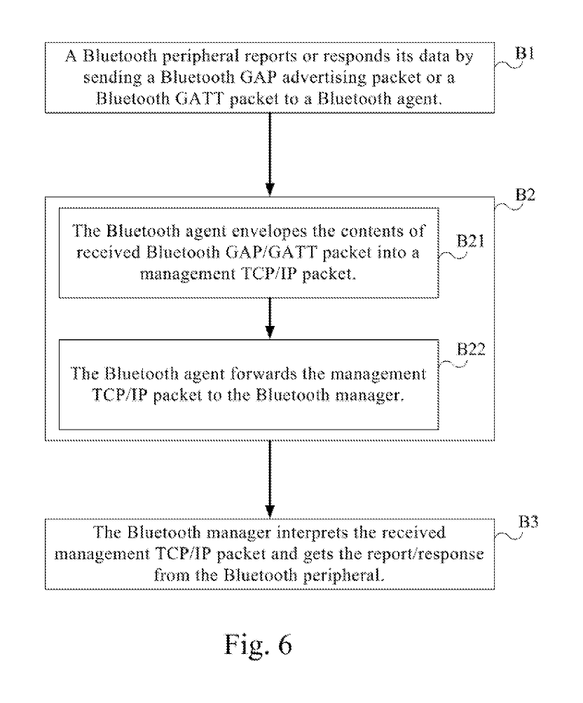

Please refer to FIG. 6. FIG. 6 shows another process flow diagram of the remote Bluetooth device communication method of the present invention. Another embodiment of the present invention comprises the following method: B1: A Bluetooth peripheral reports or responds its data by sending a Bluetooth GAP advertising packet or a Bluetooth GATT packet to a Bluetooth agent; B2: The Bluetooth agent receives the Bluetooth GAP advertising packet or Bluetooth GATT packet and encapsulated them into a Bluetooth management TCP/IP packet S4; and B3: The Bluetooth manager interprets the received management TCP/IP packet and gets the report/response from the Bluetooth peripheral. Wherein the B2 of the remote Bluetooth device communication method comprises the following method: B21: The Bluetooth agent envelopes the contents of received Bluetooth GAP/GATT packet into a management TCP/IP packet; and B22: The Bluetooth agent forwards the management TCP/IP packet to the Bluetooth manager.

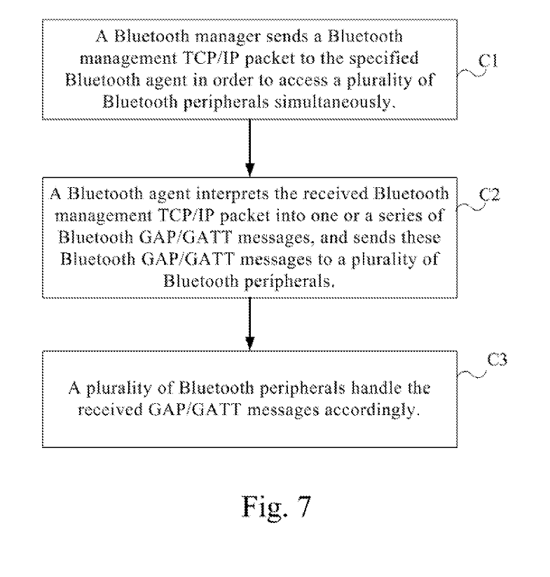

Please refer to FIG. 7. FIG. 7 shows a process flow diagram of synchronous operation of the remote Bluetooth device communication method of the present invention. Another embodiment of the present invention provides a remote Bluetooth device communication multipoint synchronous operation method comprising the following method: C1: A Bluetooth manager sends a Bluetooth management TCP/IP packet to the specified Bluetooth agent in order to access a plurality of Bluetooth peripherals simultaneously; C2: A Bluetooth agent interprets the received Bluetooth management TCP/IP packet into one or a series of Bluetooth GAP/GATT messages, and sends these Bluetooth GAP/GATT messages to a plurality of Bluetooth peripherals; and C3: A plurality of Bluetooth peripherals handle the received GAP/GATT messages accordingly.

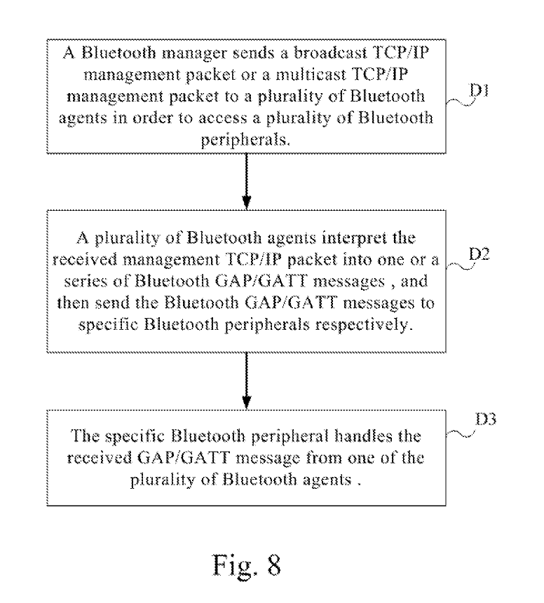

Please refer to FIG. 8. FIG. 8 shows another process flow diagram of synchronous operation of the remote Bluetooth device communication method of the present invention. Another embodiment of the present invention provides a remote Bluetooth device communication multipoint synchronous operation method comprising the following method: D1: A Bluetooth manager sends a broadcast TCP/IP management packet or a multicast TCP/IP management packet to a plurality of Bluetooth agents in order to access a plurality of Bluetooth peripherals; D2: A plurality of Bluetooth agents interpret the received management TCP/IP packet into one or a series of Bluetooth GAP/GATT messages, and then send the Bluetooth GAP/GATT messages to specific Bluetooth peripherals respectively; and D3: The specific Bluetooth peripheral handles the received GAP/GATT message from one of the plurality of Bluetooth agents.

Since nowadays Bluetooth devices can only send signals up to about meters currently, using the Bluetooth device in an outdoor space or a structure sheltering space is not enough. Therefore, the present invention is characterized in using of the internet characteristics of long-distance transmission. For the purpose of the data communication between the Bluetooth manager 10 and Bluetooth peripheral 30 across an IP network, the present invention provides a Bluetooth agent 20 to interpret the Bluetooth GAP/GATT message or the Bluetooth management TCP/IP packet unidirectionally or bidirectionally. Besides, one Bluetooth central device of the Bluetooth network can only connect to Bluetooth peripheral devices with limited number in the past. In the present invention, the Bluetooth agent 20 acts as a role of Bluetooth central while communicating with Bluetooth peripherals. A Bluetooth manager can send TCP/IP management messages to a plurality of Bluetooth agents 20, so that the number of managed Bluetooth peripherals can be extended by adding more Bluetooth agents in this network.

In summary, the present invention provides a remote Bluetooth device communication system comprising a Bluetooth manager, a Bluetooth agent, and a Bluetooth peripheral. Wherein, the Bluetooth manager sends a Bluetooth management TCP/IP packet to the Bluetooth agent. The Bluetooth agent interprets the received Bluetooth management TCP/IP packet into one or a series of Bluetooth GAP/GATT messages, and then forwards the Bluetooth GAP/GATT messages to the Bluetooth peripheral. The Bluetooth peripheral receives the Bluetooth GAP/GATT messages and executes the Bluetooth GAP/GATT operations accordingly. Another object of the present invention is to provide a remote Bluetooth device communication system. Through the step A1 to A3 or B1 to B3 of the above-mentioned steps, the Bluetooth peripherals' data can be carried over an IP network. On the other hand, through the step C1 to C3 or D1 to D3, a plurality of Bluetooth peripherals can be accessed synchronously across an IP network.

Compare to the prior art, the remote Bluetooth device communication system of the present invention encapsulates the Bluetooth messages into a TCP/IP management packet by the Bluetooth agent. Through this mechanism, the purpose of carrying the Bluetooth message over Internet could be achieved, and the manager can access a plurality of Bluetooth peripherals across Internet.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A remote Bluetooth device communication system, comprising:
a Bluetooth manager, for receiving and sending a management TCP/IP packet;
a Bluetooth agent, connected to the Bluetooth manager via a TCP/IP connection, for interpreting the management TCP/IP packet into one or a series of Bluetooth GAP/GATT messages and forwarding the Bluetooth GAP/GATT message; and
a Bluetooth peripheral, communicates to the Bluetooth agent via a Bluetooth broadcasting channel or a Bluetooth connection, for receiving the Bluetooth GAP/GATT message and executing a Bluetooth GAP/GATT operation accordingly.

2. The remote Bluetooth device communication system of claim 1, wherein the Bluetooth peripheral is a device compatible with the general IEEE802.15.1 standard.

3. The remote Bluetooth device communication system of claim 1, wherein the Bluetooth peripheral comprises a Bluetooth 4.0 or above standards.

4. A remote Bluetooth device communication system, comprising:
a Bluetooth peripheral, for receiving and sending a Bluetooth GAP/GATT message;
a Bluetooth agent, communicates to the Bluetooth peripheral via a Bluetooth broadcast channel or a Bluetooth connection, for encapsulating the Bluetooth GAT/GATT message into a management TCP/IP packet and forwarding the management TCP/IP packet; and
a Bluetooth manager, connected by the Bluetooth agent, for receiving the management TCP/IP packet.

5. The remote Bluetooth device communication system of claim 4, wherein the Bluetooth peripheral is a device compatible with the general IEEE802.15.1 standard.

6. The remote Bluetooth device communication system of claim 4, wherein the Bluetooth peripheral comprises a Bluetooth 4.0 or above standards developed by Bluetooth SIG (Bluetooth Special Interest Group).

7. A remote Bluetooth device communication system, comprising:
a Bluetooth manager, for receiving and sending a Bluetooth management TCP/IP packet;
a Bluetooth agent, connected to the Bluetooth manager through a TCP/IP connection, for interpreting the management TCP/IP packet into one or a series of Bluetooth GAP/GATT messages and forwarding the Bluetooth GAP/GATT messages to a plurality of Bluetooth peripherals; and
a plurality of Bluetooth peripherals, communicating to the Bluetooth agent on a Bluetooth broadcast channel or a Bluetooth connection, for receiving the Bluetooth GAP/GATT messages and executing a Bluetooth GAP/GATT operation accordingly.

8. The remote Bluetooth device communication system of claim 1, 4, or 7, wherein the Bluetooth manager could be a standalone software or a software module. The Bluetooth manager provides a series of API for other modules to control the Bluetooth peripherals.

9. The remote Bluetooth device communication system of claim 7, wherein the plurality of Bluetooth peripherals have the same Bluetooth GATT (Bluetooth General Attributes) services and characteristics.

10. The remote Bluetooth device communication system of claim 7, wherein the Bluetooth manager and the Bluetooth agent can be configured, wherein the Bluetooth manager and the Bluetooth agent provide the plurality of Bluetooth peripherals the corresponding Bluetooth management TCP/IP packet and the corresponding Bluetooth GAP/GATT message respectively to make each one of the plurality of Bluetooth peripherals execute action according to the corresponding command.

11. A remote Bluetooth device communication method, comprising the following steps:
A1. A Bluetooth manager sends a Bluetooth management TCP/IP packet to a Bluetooth agent;
A2. The Bluetooth agent interprets the received Bluetooth management TCP/IP packet into one or a series of Bluetooth GAP/GATT messages; and
A3. A Bluetooth peripheral receives the Bluetooth GAP/GATT messages, and executes a Bluetooth GAP/GATT operation accordingly.

12. The remote Bluetooth device communication method of claim 11, wherein the step A2 further comprises the following steps:
A21. The Bluetooth agent receives the management TCP/IP packet and interprets the management TCP/IP packet to obtain the content or the command thereof; and
A22. The Bluetooth agent interprets the management TCP/IP packet into the Bluetooth GAP/GATT messages.

13. A remote Bluetooth device communication method, comprising the following steps:
B1. A Bluetooth peripheral sends a Bluetooth GAP advertising packet or a Bluetooth GATT packet to a Bluetooth agent;
B2. The Bluetooth agent receives the Bluetooth GAP advertising packet or Bluetooth GATT packet and encapsulated the them into a Bluetooth management TCP/IP packet; and
B3. A Bluetooth manager receives the Bluetooth management TCP/IP packet.

14. The remote Bluetooth device communication method of claim 13, wherein the step B2 further comprises the following steps:
B21. The Bluetooth agent interprets the Bluetooth GAP advertising packet or the Bluetooth GATT packet to obtain the content or the command thereof; and
B22. The Bluetooth agent packetizes the content or the command interpreted from the Bluetooth GAP advertising packet or the Bluetooth GATT packet into the Bluetooth management TCP/IP packet.

15. A remote Bluetooth device communication method, comprising the following steps:
C1. A Bluetooth manager sends a Bluetooth management TCP/IP packet;
C2. A Bluetooth agent interprets the received Bluetooth management TCP/IP packet to one or a series of Bluetooth GAP/GATT messages, and sends the Bluetooth GAP/GATT messages; and
C3. A plurality of Bluetooth peripherals receive the Bluetooth GAP/GATT messages and respond to the Bluetooth agent if needed.

16. A remote Bluetooth device communication method, comprising the following steps:
D1. A Bluetooth manager sends a broadcast TCP/IP management packet or a multicast TCP/IP management packet to one or a plurality of Bluetooth agents;
D2. The plurality of Bluetooth agents interpret the TCP/IP management packet to one or a series of Bluetooth GAP/GATT messages, and then send the Bluetooth GAP/GATT messages; and
D3. A Bluetooth peripheral executes an operation of Bluetooth GAP/GATT messages from one of the plurality of Bluetooth agents.
